(19) United States
(12) Patent Application Publication
(10) Pub. No.: US 2017/0320737 A1
(43) Pub. Date: Nov. 9, 2017

(54) SOLVOTHERMAL METHOD FOR MAKING LITHIUM IRON PHOSPHATE

(71) Applicants: Jiangsu Huadong Institute of Li-Ion Battery Co., Ltd., Suzhou (CN); Tsinghua University, Beijing (CN)

(72) Inventors: XIANG-MING HE, Beijing (CN); CHENG-HAO XU, Beijing (CN); LI WANG, Beijing (CN); JIAN-JUN LI, Beijing (CN); YU-MING SHANG, Beijing (CN); JIAN GAO, Beijing (CN); YAO-WU WANG, Beijing (CN)

(73) Assignees: Jiangsu Huadong Institute of Li-Ion Battery Co., Ltd., Suzhou (CN); Tsinghua University, Beijing (CN)

(21) Appl. No.: 15/658,392

(22) Filed: Jul. 25, 2017

Related U.S. Application Data
(63) Continuation of application No. PCT/CN2016/070752, filed on Jan. 13, 2016.

(30) Foreign Application Priority Data
Jan. 27, 2015 (CN) 201510040329.5

(51) Int. Cl. C01B 25/45; H01M 4/58; H01M 10/0525; H01M 4/02

(52) U.S. Cl. CPC C01B 25/45; H01M 10/0525; H01M 4/5825; H01M 2004/028

(57) ABSTRACT

A solvothermal method for making a lithium iron phosphate is disclosed. The waste liquid of a solvothermal reaction is treated synthetically by flash evaporation and a centrifugal separation to separate the water, the organic solvent, and the lithium sulfate, which is a byproduct from each other. One part of the separated organic solvent is reused as a reaction material of the solvothermal reaction to form a organic solvent recycle circuit. The other part of the separated organic solvent is mixed with the separated water to be used as a washing liquid. The washing liquid is retreated by flash evaporation and centrifugal separation to obtain the water and the organic solvent again to form a washing liquid circuit.

### CROSS-REFERENCE TO RELATED APPLICATIONS

This application claims all benefits accruing under 35 U.S.C. §119 from China Patent Application No. 201510040329.5, filed on Jan. 27, 2015 in the State Intellectual Property Office of China, the content of which is hereby incorporated by reference. This application is a continuation under 35 U.S.C. §120 of international patent application PCT/CN2016/070752 filed on Jan. 13, 2016, the content of which is also hereby incorporated by reference.

### FIELD

The present disclosure relates to preparations of cathode active materials for lithium ion batteries, especially to solvothermal methods for making lithium iron phosphates.

### BACKGROUND

Lithium iron phosphate is an important cathode active material for a lithium ion battery, and has been widely used in energy storage batteries and power batteries. A solid phase synthesis method and a liquid phase synthesis method are two conventional methods for making the lithium iron phosphate. Ferrous oxalate based method, ferric oxide based method, and iron phosphate based method are representative solid phase synthesis methods.

The solid phase synthesis method is the most widely used method for making the lithium iron phosphate due to its low production cost. However, the lithium iron phosphate made by the solid phase synthesis method has a non-uniform size distribution and a poor controllability, limiting the electrochemical performance of the lithium iron phosphate.

A solvothermal method is a representative liquid phase synthesis method. The liquid phase method, especially the solvothermal method, has advantages such as easy to achieve continuous low-temperature synthesis and in situ carbonization, and high purity of the product, uniform size distribution, and excellent electrochemical performance of the product. However, a reaction medium used in the liquid phase synthesis method is a mixture of water and organic solvent, and a large amount of waste liquid is generated during the production process. How to deal the waste liquid and recycle the lithium resource and the organic solvent are key factors to implement the liquid phase synthesis method. Because the lithium salt is dissolved in the waste liquid, the lithium salt and the organic solvent are commonly recycled by using a distillation method. However, a complicated distillation apparatus used in the distillation method and a high energy consumption of the distillation greatly increase the production cost of the lithium iron phosphate. On the other hand, if the lithium salt and the organic solvent are not recycled, the production cost of the lithium iron phosphate also increases due to the waste of the lithium salt and the organic solvent.

### SUMMARY

A solvothermal method for making lithium iron phosphate comprises following steps of:

S1, providing an organic solvent, ferrous sulfate, lithium hydroxide, and a phosphoric acid solution, wherein the phosphoric acid solution comprises water and phosphoric acid;

S2, mixing the organic solvent, the ferrous sulfate, the lithium hydroxide, and the phosphoric acid solution to obtain a precursor solution;

S3, solvothermal reacting the precursor solution to obtain a first suspension liquid;

S4, filtering the first suspension liquid to obtain a wet lithium iron phosphate material and a filtrate, wherein the filtrate comprises the organic solvent, water, and lithium sulfate;

S5, flash evaporating the filtrate to respectively obtain water and a second suspension liquid, wherein the second suspension liquid comprises the organic solvent and the lithium sulfate, and the lithium sulfate is suspended in the organic solvent as a precipitate;

S6, separating the lithium sulfate from the organic solvent in the second suspension liquid, wherein a first part of the organic solvent can be reused in S1, and a second part of the organic solvent can be used in S7;

S7, mixing the water obtained in S5 and the second part of the organic solvent obtained in S6 to form a first washing liquid, and countercurrent washing the wet lithium iron phosphate material by using the first washing liquid to obtain a purified wet lithium iron phosphate material and a second washing liquid, wherein the second washing liquid has the same composition with the filtrate, and the second washing liquid is returned to S5 and flash evaporated together with the filtrate; and

S8, drying the purified wet lithium iron phosphate material.

In one embodiment of the present disclosure, the lithium iron phosphate made by the solvothermal method can have a high quality and a low production cost. The waste liquid of the solvothermal reaction is synthetically treated by a flash evaporation and a centrifugal separation, and synthetically recycled by two recycle circuits. The water, the organic solvent, and the lithium sulfate, which is a byproduct, in the waste liquid can be separated from each other quickly and effectively. An amount of fresh organic solvent used in the solvothermal reaction can be reduced, and the production cost can be greatly decreased. The lithium iron phosphate with high purity, uniform size distribution, and excellent electrochemical performance can be produced, without generating secondary pollutant such as waste liquid, waste residue, and waste gas. The solvothermal method of the present disclosure is energy efficient and environmentally friendly.

### BRIEF DESCRIPTION OF THE DRAWINGS

Implementations are described by way of example only with reference to the attached figures.

FIG. 1 is a flow chart of one embodiment of a solvothermal method for making lithium iron phosphate.

FIG. 2 is a schematic view of one embodiment of a solvothermal apparatus for making lithium iron phosphate.

### DETAILED DESCRIPTION

A detailed description with the above drawings is made to further illustrate the present disclosure.

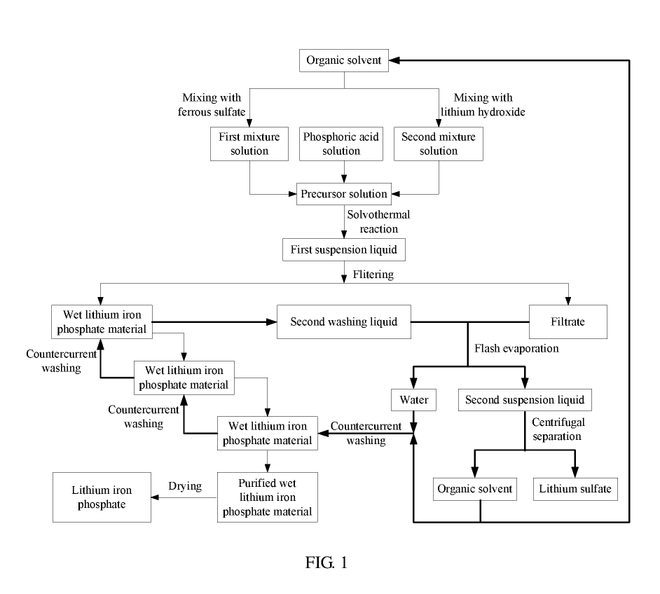

Referring to FIG. 1, one embodiment of a solvothermal method for making lithium iron phosphate comprises the following steps of:

S1, providing an organic solvent, ferrous sulfate, lithium hydroxide, and a phosphoric acid solution, wherein the phosphoric acid solution comprises water and phosphoric acid;

S2, mixing the organic solvent, ferrous sulfate, lithium hydroxide, and the phosphoric acid solution to obtain a precursor solution;

S3, solvothermal reacting the precursor solution to obtain a first suspension liquid;

S4, filtering the first suspension liquid to obtain a wet lithium iron phosphate material and a filtrate, wherein the filtrate comprises the organic solvent, water, and lithium sulfate;

S5, flash evaporating the filtrate to respectively obtain water and a second suspension liquid, wherein the second suspension liquid comprises the organic solvent and lithium sulfate, and lithium sulfate is suspended in the organic solvent as a precipitate;

S6, separating lithium sulfate from the organic solvent in the second suspension liquid, wherein a first part of the organic solvent can be reused in S1, and a second part of the organic solvent is used in S7;

S7, mixing the water obtained in S5 and the second part of the organic solvent obtained in S6 to obtain a first washing liquid, and countercurrent washing the wet lithium iron phosphate material by using the first washing liquid to obtain a purified wet lithium iron phosphate material and a second washing liquid, wherein the second washing liquid has the same composition with the filtrate, and the second washing liquid can be returned to S5 and flash evaporated together with the filtrate; and

S8, drying the purified wet lithium iron phosphate material.

In S1, the organic solvent and water can be miscible with each other. Ferrous sulfate and lithium hydroxide can be dissolved in the organic solvent. Lithium sulfate cannot be dissolved in the organic solvent. The organic solvent can be selected from ethanol, ethylene glycol, glycerol, diethylene glycol, triethylene glycol, tetraethylene glycol, butanetriol, n-butanol, isobutanol, and combinations thereof. In one embodiment, the organic solvent can be selected from ethanol, ethylene glycol, glycerol, and combinations thereof. In one embodiment, the organic solvent can be ethylene glycol. Ferrous sulfate can be ferrous sulfate heptahydrate (FeSO₄.7H₂O). Lithium hydroxide can be lithium hydroxide monohydrate (LiOH.H₂O). A mass percentage of phosphoric acid in the phosphoric acid solution can be in a range from about 40% to about 86%. In one embodiment, the mass percentage of phosphoric acid in the phosphoric acid solution can be about 85%.

In S2, the organic solvent and water are mixed to form a solvent mixture in the precursor solution. The solvent mixture can be a reaction medium for the solvothermal reaction. A molar ratio of lithium hydroxide to ferrous sulfate can be equal to or larger than about 3:1 to ensure that all ferrous ions in ferrous sulfate can be transferred into lithium iron phosphate during the solvothermal reaction.

The method for mixing the organic solvent, ferrous sulfate, lithium hydroxide, and the phosphoric acid solution is not limited as long as the precursor solution can be obtained. In one embodiment, one part of the organic solvent and ferrous sulfate can be mixed to form a first mixture solution. The other part of the organic solvent and lithium hydroxide can be mixed to form a second mixture solution. The first mixture solution, the second mixture solution, and the phosphoric acid solution can be mixed to form the precursor solution.

In S3, lithium iron phosphate can be produced and dispersed into the solvent mixture during the solvothermal reaction. The first suspension liquid can comprise lithium iron phosphate, the solvent mixture, and lithium sulfate, which is the byproduct of the solvothermal reaction. The solvothermal reaction can be carried out at a temperature in a range from about 120° C. to about 300° C., and under a pressure in a range from about 0.2 MPa to about 2.0 MPa for about 0.5 hours to about 10 hours.

In the S4, the first suspension liquid can be filtered by a common filtration method, such as a pressure reducing filtration method, a pressure increasing filtration method, or a vacuum filtration method. In one embodiment, the first suspension liquid can be filtered by using a continuous precision membrane filter. The first suspension liquid can be filtered at a temperature in a range from about 80° C. to about 180° C., during which the first suspension liquid can be filtered quickly and effectively due to a low viscosity thereof. In one embodiment, the first suspension liquid can be filtered at a temperature in a range from about 100° C. to about 140° C.

In S5, water can be directly recycled from the filtrate by the flash evaporation, during which lithium sulfate can be precipitated out from the organic solvent to form the second suspension liquid. The filtrate may comprise a small amount of unreacted phosphate radical, and the unreacted phosphate radical can also be precipitated out from the organic solvent during the flash evaporation. Thus the second suspension may comprise a small amount of lithium phosphate as a precipitate.

The flash evaporation is a process in which saturated water under a high pressure is boiling and evaporated into water vapor quickly due to a sudden drop of pressure after the high pressure saturated water enters a low pressure container. In one embodiment, the flash evaporation can comprise following steps of:

S51, preheating the filtrate under atmospheric pressure to a temperature in a range from about 100° C. to about 160° C. in a preheating device; and

S52, transferring the filtrate preheated to the temperature in the range from about 100° C. to about 160° C. into a liquid-vapor separator, an inner pressure of the liquid-vapor separator is in a range from about 3 kPa to about 60 kPa.

At the temperature in the range from about 100° C. to about 160° C., water in the filtrate can be saturated. When the filtrate enters into the liquid-vapor separator with the pressure in the range from about 3 kPa to about 60 kPa, the saturated water can be boiling and evaporated into the water vapor quickly, and separated from the filtrate quickly.

In S6, lithium sulfate as the byproduct and the organic solvent can be quickly separated from each other by a solid-liquid separation method. The separated lithium sulfate can be treated with a strong base, such as sodium hydroxide, to form lithium hydroxide. The first part, which can be a majority of the separated organic solvent, can be reused in S1. The second part of the separated organic solvent can be mixed with the water obtained in S6 to form the first washing liquid to countercurrent wash the wet lithium iron phosphate material. The small amount of lithium phosphate precipitate can also be separated from the organic solvent together with the lithium sulfate. In one embodiment, the solid-phase separation method is a centrifugal separation method.

In S7, an impurity such as sulfate radicals and lithium ions adsorbed on the wet lithium iron phosphate material can be removed during the countercurrent washing to purify the wet lithium iron phosphate material. The countercurrent washing can be a multistage countercurrent washing, such as a three-stage countercurrent washing. A component of the second washing liquid can be the same as a component of the filtrate. The second washing liquid can be reintroduced into S6 to be flash evaporated together with the filtrate.

In S8, the purified wet lithium iron phosphate material can be dried by a conventional drying method, such as a natural air drying method, a spray drying method, a heat drying method, a vacuum drying method, or a microwave drying method.

In the present disclosure, two recycle circuits are provided to recycle the waste liquid of the solvothermal reaction. One recycle circuit is an organic solvent recycle circuit, in which the first part of the organic solvent recycled from the waste liquid is reused in the solvothermal reaction. The other recycle circuit is a washing liquid recycle circuit, in which the water and the second part of the organic solvent both recycled from the waste liquid are mixed to form the first washing liquid to countercurrent wash the wet lithium iron phosphate material. After the countercurrent washing, the second washing liquid is recycled to obtain the water and the organic solvent again.

In an embodiment of the present disclosure, the lithium iron phosphate made by the solvothermal method can have a high quality and a low production cost. The waste liquid of the solvothermal reaction is treated synthetically by a flash evaporation and a centrifugal separation to separate the water, the organic solvent, and the lithium sulfate, which is a byproduct from each other, quickly and effectively. The flash evaporation and the centrifugal separation are simple to operate and easy to realize, and has low energy consumption, thereby decreasing the production cost of the lithium iron phosphate. The waste liquid can be recycled by the two recycle circuits, thereby greatly decreasing an amount of fresh organic solvent used in the solvothermal reaction, and further decreasing the production cost of lithium iron phosphate. Compared to the conventional solvothermal method, an amount of the organic solvent that is used can be decreased to 1 cubic meter per ton of lithium iron phosphate from 32 cubic meters per ton of lithium iron phosphate, and the production cost of the lithium iron phosphate can be thereby decreased.

In the present disclosure, the lithium iron phosphate with high purity, uniform size distribution, and excellent electrochemical performance can be continuously produced at a relatively low temperature. An in-situ carbonization is easy to be implemented during production. No secondary pollutant such as waste liquid, waste residue, and waste gas is generated during the production. The solvothermal method for making the lithium iron phosphate is energy efficient and environmentally friendly.

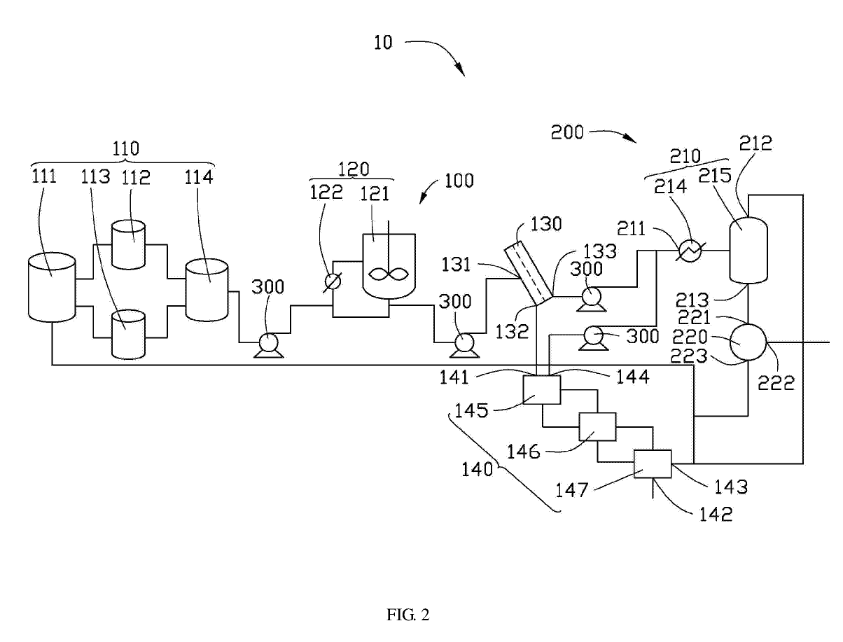

Referring to FIG. 2, one embodiment of a solvothermal apparatus 10 for making the lithium iron phosphate comprises a manufacture unit 100 and a recycle unit 200. The manufacture unit 100 can comprise a feeding device 110, a reaction device 120, a filtering device 130, and a countercurrent washing device 140. The feeding device 110, the reaction device 120, the filtering device 130, and the countercurrent washing device 140 can be sequentially connected to each other. The recycle unit 200 can comprise a flash evaporation device 210 and a solid-liquid separation device 220 connected with the flash evaporation device 210.

The feeding device 110 is configured to transport materials to the reaction device 120. The materials can comprise the organic solvent, the ferrous sulfate, the lithium hydroxide, and the phosphoric acid solution. The feeding device 110 can comprise an organic solvent container 111, a first mixing tank 112, a second mixing tank 113, and a third mixing tank 114. The first mixing tank 112 and the second mixing tank 113 can be respectively connected to the organic solvent container 111, and simultaneously connected to the third mixing tank 114. The organic solvent container 111 is configured to transport the organic solvent respectively to the first mixing tank 112 and the second mixing tank 113. The first mixing tank 112 is configured to mix the organic solvent with the ferrous sulfate to form the first mixture solution. The second mixing tank 113 is configured to mix the organic solvent with the lithium hydroxide to form the second mixture solution. The third mixing tank 114 is configured to mix the first mixture solution, the second mixture solution, and the phosphoric acid solution to form the precursor solution. The precursor solution is the reaction material. It is understood that the feeding device 110 can be varied according to needs.

The reaction device 120 is configured to solvothermal react the reaction material to obtain the lithium iron phosphate. The reaction device 120 can comprise a solvothermal reactor 121 in which the solvothermal reaction is carried out. The solvothermal reactor 121 can be a reactor capable of providing a high temperature and a high pressure to the reaction material. The solvothermal reactor 121 can be a sealed autoclave. During the solvothermal reaction, the pressure inside the sealed autoclave can be increased by applying an outer pressure to the sealed autoclave or by a vapor generated from the reaction material in the autoclave. The reaction device 120 can further comprise a metering device 122. The metering device 122 is configured to control an amount of the reaction material introduced into the solvothermal reactor 121.

The filtering device 130 is configured to filter the first suspension liquid. A filtering inlet 131, a filtering solid outlet 132, and a filtering liquid outlet 133 can be defined on the filtering device 130. The filtering inlet 131 can be connected to the reaction device 120. The first suspension liquid can be transported into the filtering device 130 through the filtering inlet 131. The filtering solid outlet 132 can be connected to the countercurrent washing device 140. The wet lithium iron phosphate material can be transported into the countercurrent washing device 140 through the filtering solid outlet 132. The filtering liquid outlet 133 can be connected to the flash evaporation device 210. The filtrate can be transported into the flash evaporation device 210 through the filtering liquid outlet 133. The filtering device 130 can be a tubular filter, a continuous pressure filter, a membrane filter, or a vacuum filter. In one embodiment, the filtering device 130 can be a continuous precision membrane filter.

The countercurrent washing device 140 is configured to wash and purify the wet lithium iron phosphate material. A washing solid inlet 141, a washing solid outlet 142, a washing liquid inlet 143, and a washing liquid outlet 144 can be defined on the countercurrent washing device 140. The washing solid inlet 141 can be connected to the filtering solid outlet 132. The wet lithium iron phosphate material can be transported into the countercurrent washing device 140 through the washing solid inlet 141, and discharged from the countercurrent washing device 140 through the washing solid outlet 142. The washing liquid inlet 143 can be connected respectively to the flash evaporation device 210 and the solid-liquid separation device 220. The water recycled by the flash evaporation device 210 and the organic solvent recycled by the solid-liquid separation device 220 can be simultaneously transported into the countercurrent washing device 140 through the washing liquid inlet 143. The washing liquid outlet 144 can be connected to the flash evaporation device 210. The second washing liquid can be transported into the flash evaporation device 210 through the washing liquid outlet 144.

The countercurrent washing device 140 can be a three-stage countercurrent washing device. The countercurrent washing device 140 can comprise a first washing sink 145, a second washing sink 146, and a third washing sink 147 sequentially connected to each other. The washing solid inlet 141 and the washing liquid outlet 144 can be defined on the first washing sink 145. The washing solid outlet 142 and the washing liquid inlet 143 can be defined on the third washing sink 147. During the countercurrent washing, the wet lithium iron phosphate can be moved from the first washing sink 145 to the third washing sink 147, meanwhile, the first washing liquid comprises the organic solvent and water can be moved from the third washing sink 147 to the first washing sink 145.

The flash evaporation device 210 is configured to directly recycle the water from the filtrate and the second washing liquid to obtain the second suspension liquid. An evaporation liquid inlet 211, a first evaporation liquid outlet 212, and a second evaporation liquid outlet 213 can be defined on the flash evaporation device 210. The evaporation liquid inlet 211 can be respectively connected to the filtering liquid outlet 133 and the washing liquid outlet 144. The filtrate and the second washing liquid can be transported into the flash evaporation device 210 through the evaporation liquid inlet 211. The first evaporation liquid outlet 212 can be connected to the washing liquid inlet 143, the water obtained by the flash evaporation device 210 can be transported into the countercurrent washing device 140 through the first evaporation liquid outlet 212. The second evaporation liquid outlet 213 can be connected to the solid-liquid separation device 220. The second suspension liquid obtained by the flash evaporation device 210 can be transported into the solid-liquid separation device 220 through the second evaporation liquid outlet 213.

The flash evaporation device 210 can comprise a pre-heater 214 and a vapor-liquid separator 215. The pre-heater 214 is configured to heat the filtrate and the second washing liquid to saturate the water contained in the filtrate and the second washing liquid. The vapor-liquid separator 215 is configured to provide a vacuum environment in which the saturated water transported from the pre-heater 214 can be vaporized quickly. The evaporation liquid inlet 211 can be defined on the pre-heater 214. The first evaporation liquid outlet 212 and the second evaporation liquid outlet 213 can be defined on the vapor-liquid separator 215.

The solid-liquid separating device 220 is configured to separate the lithium sulfate from the organic solvent in the second suspension liquid. A separation inlet 221, a separation solid outlet 222, and a separation liquid outlet 223 can be defined on the solid-liquid separating device 220. The separation inlet 221 can be connected to the evaporation solid outlet 213. The second suspension liquid can be transported into the solid-liquid separating device 220 through the separation inlet 221. The lithium sulfate can be discharged through the separation solid outlet 222. The separation liquid outlet 223 can be connected respectively to the washing liquid inlet 143 and the feeding device 110. One part of the organic solvent obtained by the solid-liquid separating device 220 can be returned to the feeding device 110 to be reused. The other part of the organic solvent obtained by the solid-liquid separating device 220 can be transported into the countercurrent washing device 140 together with the water obtained by the flash evaporation device 210 to form the first washing liquid to wash and purify the wet lithium iron phosphate material. The solid-liquid separation device 220 can be a centrifugal separator.

The apparatus 10 can further comprise a plurality of delivery pumps 300. The plurality of delivery pumps 300 are configured to transport liquid materials from one device to another device.

In the present disclosure, the waste liquid of the solvothermal reaction is treated synthetically by the flash evaporation device and the solid-liquid separation device having a simple structure and a low energy consumption. The water, the organic solvent, and the byproduct lithium sulfate can be separated from each other quickly and effectively by the apparatus 10. The first evaporation liquid outlet and the separation liquid outlet are respectively connected to the washing liquid inlet, so that the water recycled by the flash evaporation device and the organic solvent recycled by the solid-liquid separation device can be reused to countercurrent wash the wet lithium iron phosphate material. The washing liquid outlet can be further connected to the evaporation liquid inlet, so that after the countercurrent washing, the second washing liquid can be returned to the flash evaporation device to be recycled. Thus, the washing liquid recycle circuit is established. The separation liquid outlet can also be connected to the feeding device, so that the organic solvent recycled from the solid-liquid separation device can be returned to the feeding device to be reused. Thus, the organic solvent recycle circuit is established. The organic solvent can be recycled in the two recycling circuits, so that only a small amount of fresh organic solvent would be needed during continuous production of the lithium iron phosphate, which greatly decreases the production cost of the lithium iron phosphate.

Finally, it is to be understood that the above-described embodiments are intended to illustrate rather than limit the present disclosure. Variations may be made to the embodiments without departing from the spirit of the present disclosure as claimed. Elements associated with any of the above embodiments are envisioned to be associated with any other embodiments. The above-described embodiments illustrate the scope of the present disclosure but do not restrict the scope of the present disclosure.

What is claimed is:

1. A solvothermal method for making lithium iron phosphate, comprising:
providing a precursor solution for synthesizing lithium iron phosphate, wherein the precursor solution comprises a solvent mixture comprising an organic solvent and water;
solvothermal reacting the precursor solution to obtain a first suspension liquid;
filtering the first suspension liquid to obtain a wet lithium iron phosphate material and a filtrate, wherein the filtrate comprises the organic solvent, the water, and a byproduct of the solvothermal reacting;
flash evaporating the filtrate to respectively obtain the water and a second suspension liquid, wherein the second suspension liquid comprises the organic solvent and the byproduct suspended in the organic solvent;
separating the byproduct from the organic solvent of the second suspension liquid;
mixing the water obtained from flash evaporating the filtrate and a part of the organic solvent obtained from separating the byproduct from the organic solvent of the second suspension liquid to obtain a first washing liquid, and countercurrent washing the wet lithium iron phosphate material by using the first washing liquid to obtain a purified wet lithium iron phosphate material and a second washing liquid; and
drying the purified wet lithium iron phosphate material to obtain the lithium iron phosphate.

2. The solvothermal method of claim 1 further comprising reintroducing the second washing liquid and flash evaporating the second washing liquid together with the filtrate.

3. The solvothermal method of claim 2, wherein the second washing liquid and the filtrate have the same composition.

4. The solvothermal method of claim 1, wherein the providing a precursor solution for synthesizing lithium iron phosphate comprises:
providing the organic solvent, ferrous sulfate, lithium hydroxide, and a phosphoric acid solution, wherein the phosphoric acid solution comprises water and phosphoric acid;
mixing the organic solvent, the ferrous sulfate, the lithium hydroxide, and the phosphoric acid solution to obtain the precursor solution.

5. The solvothermal method of claim 4, wherein the organic solvent and the water are miscible with each other, the ferrous sulfate and the lithium hydroxide are dissolvable in the organic solvent, and the byproduct is insoluble in the organic solvent.

6. The solvothermal method of claim 4, wherein the organic solvent is selected from the group consisting of ethanol, ethylene glycol, glycerol, diethylene glycol, triethylene glycol, tetraethylene glycol, butanetriol, n-butanol, isobutanol, and combinations thereof.

7. The solvothermal method of claim 4, wherein a molar ratio of the lithium hydroxide to the ferrous sulfate in the precursor solution is equal to or larger than 3:1.

8. The solvothermal method of claim 4, wherein the byproduct is lithium sulfate.

9. The solvothermal method of claim 4, wherein the mixing the organic solvent, the ferrous sulfate, the lithium hydroxide, and the phosphoric acid solution comprises:
mixing one part of the organic solvent and the ferrous sulfate to form a first mixture solution;
mixing another part of the organic solvent and the lithium hydroxide to form a second solution; and
mixing the first mixture solution, the second mixture solution, and the phosphoric acid solution to form the precursor solution.

10. The solvothermal method of claim 1, wherein in the solvothermal reacting the precursor solution to obtain a first suspension liquid, the solvothermal reacting is carried out at a temperature in a range from about 120° C. to about 300° C., and under a pressure in a range from about 0.2 MPa to about 2.0 Mpa for about 0.5 hours to about 10 hours.

11. The solvothermal method of claim 1, wherein in the filtering the first suspension liquid to obtain a wet lithium iron phosphate material and a filtrate, the first suspension liquid is filtered at a temperature in a range from about 80° C. to about 180° C.

12. The solvothermal method of claim 11, wherein the first suspension liquid is filtered at a temperature in a range from about 100° C. to about 140° C.

13. The solvothermal method of claim 1, wherein the flash evaporating the filtrate to respectively obtain the water and a second suspension liquid comprises:
preheating the filtrate under atmospheric pressure to a temperature in a range from about 100° C. to about 160° C.; and
transferring the filtrate preheated to the temperature in the range from about 100° C. to about 160° C. into a liquid-vapor separator with a pressure in a range from about 3 kPa to about 60 kPa.

14. The solvothermal method of claim 1, wherein in the separating the byproduct from the organic solvent of the second suspension liquid, the lithium sulfate is separated from the organic solvent by a centrifugal separation method.

15. The solvothermal method of claim 1, wherein in the mixing the water obtained from flash evaporating the filtrate and a part of the organic solvent obtained from separating the byproduct from the organic solvent of the second suspension liquid, the wet lithium iron phosphate material is washed by a three-stage countercurrent washing method.

16. The solvothermal method of claim 1, wherein the second suspension liquid further comprises lithium phosphate.

17. The solvothermal method of claim 1, wherein the organic solvent separated from the second suspension liquid is reused in the precursor solution.
